(19) United States
(12) Patent Application Publication
(10) Pub. No.: US 2026/0067712 A1
(43) Pub. Date: Mar. 5, 2026

(54) ELECTROMAGNETIC WAVE GENERATION SYSTEM AND GROUND STATION

(71) Applicant: Hitachi, Ltd., Tokyo (JP)

(72) Inventors: Yosuke TANABE, Tokyo (JP); Tsukasa FUNANE, Tokyo (JP); Hisatoshi KIMURA, Tokyo (JP); Makoto ITO, Tokyo (JP); Koichi WATANABE, Tokyo (JP); Shinichi SAITO, Tokyo (JP)

(21) Appl. No.: 19/250,899

(22) Filed: Jun. 26, 2025

(30) Foreign Application Priority Data
Aug. 28, 2024 (JP) 2024-146450

(51) Int. Cl. H04W 16/28; H04B 7/06

(52) U.S. Cl. CPC H04W 16/28; H04B 7/06

(57) ABSTRACT

To provide an electromagnetic wave generation system capable of generating structured electromagnetic waves by leveraging the flexibility of OAM-containing waves to detect changes in wave structure during interactions with objects and enable applications in radar and sensors. The system comprises a computing device and an electromagnetic wave generation device. The computing device includes: an input unit for receiving inputs such as an orthogonal basis pair, geometric structural information (azimuth, elevation, radius, rotation angle); a rotation operation unit to rotate geometric information based on the rotation angle; and a display unit to visualize a sphere with the orthogonal basis pair at the poles and rotated geometric information. The electromagnetic wave generation device includes: a complex signal conversion unit to convert rotated geometric information into complex signals for antenna elements; a wireless processing unit to transform complex signals into wireless signals; and an array antenna to output the wireless signals.

### CROSS-REFERENCE TO RELATED APPLICATION

The present application claims priority from Japanese Patent application serial no. 2024-146450, filed on Aug. 28, 2024, the content of which is hereby incorporated by reference into this application.

### BACKGROUND

The present invention relates to an electromagnetic wave generation system and a ground station.

An electromagnetic wave is radiated in association with an accelerated motion, and, in the process of propagation, it is absorbed by various atoms, scattered, and induces release of a newly generated electromagnetic wave. In such a case, exchange of momentum caused by an interaction between radiation and an object allows the electromagnetic wave to capture many kinds of information. The electromagnetic wave, thus, has been utilized in various applications not only to communication but also operations of radar imaging, object detection, and the like.

The electromagnetic wave has two types of angular momentum, including spin angular momentum (SAM) and orbital angular momentum (OAM). The SAM involves a polarization state, and is known to be capable of geometrically analyzing change in the polarization state caused by the interaction between radiation and an object in accordance with two bases of horizontal and vertical polarizations, or right-handed and left-handed circular polarizations. Especially, the technique called radar polarimetry has progressed, attributable to the ability of analyzing the polarization state that is changed by the scatterer with respect not only to amplitude unique to the scatterer but also the geometric phase.

Compared with the SAM having only two bases, the OAM has theoretically infinite bases with respect to left-handed/right-handed directions of the spiral azimuth angular phase, and corresponding rotation numbers (hereinafter referred to as OAM order). An attempt has been made to apply the OAM that attracts considerable attention owing to the feature as described above to the optical field such as high-speed and large-capacity optical communication, detection of a rotating object, laser machining, and to the electromagnetic wave field such as a synthetic aperture radar (SAR), detection/recognition of an object, and the like.

The OAM transmission technique is disclosed in, for example, Japanese Unexamined Patent Application Publication No. 2022-178498. In the disclosure, aiming at prevention of reduction in the peak power and in the transmission rate during the OAM multiplex transmission, the “receiver includes a reception processing unit, a signal separation unit, and a transmission signal estimation unit. The reception processing unit executes clipping processing to remove amplitude equal to or larger than the threshold from a transmission signal generated by precoding two or more integer number of transmission data sets, and receives the transmission signal from a transmitter that outputs a plurality of transmission signals in the same frequency band simultaneously, or substantially simultaneously. The signal separation unit separates the same number of reception data sets as the number of the transmission data sets by inverse conversion of the precoding processing to the received transmission signal. The transmission signal estimation unit that estimates the transmission data set by estimating components of signal distortion and noise, derived from the clipping processing, and an interference component between the transmission signals based on gain information concerning the transmission path through which the reception data set and the transmission signal are transmitted, and removing the estimated components of the signal distortion, noise, and interference from the reception data set” (claim 1).

### SUMMARY

The OAM-containing electromagnetic wave captures various types of information by exchange of momentum in the course of the interaction between radiation and an object in the carrying process. The captured information is read as an amount of change of the electromagnetic wave structure to allow application to the radar and the sensor.

As for the OAM transmission/reception as disclosed in Japanese Unexamined Patent Application Publication No. 2022-178498, each OAM mode is used as the carrier wave of the input bit sequence. Accordingly, the interaction such as diffraction and scattering tends to be regarded as the noise that deteriorates the carried information. The disclosed technique, thus, cannot read the amount of change in the electromagnetic wave structure in the course of the interaction between radiation and an object.

It is an object of the present invention to provide an electromagnetic wave generation system that generates a structured electromagnetic wave structured by utilizing flexibility of the OAM-containing electromagnetic wave to detect change in the electromagnetic wave structure in the course of the interaction between radiation and an object, and to ensure application to the radar and the sensor.

As a solution to the above-described problem, the electromagnetic wave generation system is provided with a computing device and an electromagnetic wave generation device. The computing device includes: an input unit that receives inputs including an orthogonal basis pair of mutually orthogonal first and second orthogonal bases, geometric structural information containing an azimuth angle, an elevation angle, a radius, and a rotation angle; a rotation operation unit that rotates the geometric structural information based on the rotation angle; and a display unit that displays a sphere having the orthogonal basis pair placed on a north pole and a south pole, and the rotated geometric structural information on the sphere. The electromagnetic wave generation device includes: a complex signal conversion unit that converts the rotated geometric structural information into the same number of complex signals as the number of antenna elements; a wireless processing unit that converts the complex signal into a wireless signal; and an array antenna that outputs the wireless signal.

In the present invention, for example, orthogonal bases (example: left-handed OAM, right-handed OAM) are placed on a north pole and a south pole of a virtual sphere, respectively to generate a structured electromagnetic wave having its state defined by an azimuth angle, an elevation angle, and a radius of the sphere. This allows multivalued generation/detection on the spherical state, and definition of change in the structure caused by a scatterer and the propagation process in accordance with changes in the rotation, radius, and phase of the sphere. As an arbitrary orthogonal basis can be selected, the orthogonal basis agreed between a transmitter and a receiver is used as the key so that secure communication is attained.

Objects, configurations, and effects other than the above will be apparent from the description of the following embodiments.

### BRIEF DESCRIPTION OF THE DRAWINGS

FIG. 1 illustrates a structure example of an electromagnetic wave generation system in a first embodiment according to the present invention;

FIG. 2A illustrates an example of an orthogonal basis in the first embodiment according to the present invention;

FIG. 2B illustrates an example of an orthogonal basis in the first embodiment according to the present invention;

FIG. 2C illustrates an example of an orthogonal basis in the first embodiment according to the present invention;

FIG. 2D illustrates an example of an orthogonal basis in the first embodiment according to the present invention;

FIG. 3A illustrates an example of an electric field phase map of a left-handed orbital angular momentum in the first embodiment according to the present invention;

FIG. 3B illustrates an example of an electric field phase map of a right-handed orbital angular momentum in the first embodiment according to the present invention;

FIG. 4 represents an electric field generation flow in the first embodiment according to the present invention;

FIG. 5 illustrates a display example of geometric structural information in the first embodiment according to the present invention;

FIG. 6 illustrates a display example of geometric structural information in the first embodiment according to the present invention;

FIG. 7 illustrates a display example of geometric structural information in the first embodiment according to the present invention;

FIG. 8A illustrates change in the geometric structural information in the first embodiment according to the present invention;

FIG. 8B illustrates change in the geometric structural information in the first embodiment according to the present invention;

FIG. 8C illustrates change in the geometric structural information in the first embodiment according to the present invention;

FIG. 9 illustrates a structure example of an electromagnetic wave generation system in a second embodiment according to the present invention;

FIG. 10 illustrates a display example of geometric structural information in the second embodiment according to the present invention;

FIG. 11 illustrates a structure example of an electromagnetic wave generation system in a third embodiment according to the present invention;

FIG. 12 represents an electric field generation flow in the third embodiment according to the present invention;

FIG. 13A illustrates a display example of geometric structural information in the third embodiment according to the present invention;

FIG. 13B illustrates a display example of geometric structural information in the third embodiment according to the present invention;

FIG. 14 illustrates an example of an array antenna in a fourth example according to the present invention;

FIG. 15 illustrates a configuration example of a ground station and a spacecraft in a fifth embodiment according to the present invention;

FIG. 16 illustrates a structure example of an electromagnetic wave generation system in a sixth embodiment according to the present invention;

FIG. 17 illustrates an example of an array speaker in the sixth embodiment according to the present invention;

FIG. 18 illustrates a display example of geometric structural information in the sixth embodiment according to the present invention;

FIG. 19 illustrates an example that transition of the geometric structural information is converted into an audio signal in the sixth embodiment according to the present invention;

FIG. 20A illustrates a characteristic of a sound wave radiated from the array speaker in the sixth embodiment according to the present invention;

FIG. 20B illustrates a characteristic of a sound wave radiated from the array speaker in the sixth embodiment according to the present invention;

FIG. 20C illustrates a characteristic of a sound wave radiated from the array speaker in the sixth embodiment according to the present invention; and

FIG. 20D illustrates a characteristic of a sound wave radiated from the array speaker in the sixth embodiment according to the present invention.

### DETAILED DESCRIPTION

Modes (Embodiments) for carrying out the present invention will be described in detail with reference to the drawings appropriately. An embodiment as an exemplary case for explaining the present invention is suitably omitted and simplified for clarifying the description. The present invention may be implemented in various other forms. Unless otherwise specifically limited, it is possible to use either single unit or a plurality of units of the respective components. In the respective embodiments, each component with the identical name has an identical function.

The position, size, shape, range, and the like of each of the configurations illustrated in the diagrams and the like may not express the actual position, size, shape, range, and the like in order to make the present invention easily understood. Therefore, the present invention is not limited to the positions, sizes, shapes, ranges, and the like disclosed in the diagrams and the like.

In the following description about processing by the program, the program, function units, and the like may be expressed as the subject that executes the processing. In this case, the subject as the hardware for them may be a processor, or an information processor (computer) including the processor itself. The information processor allows the processor to execute processing in accordance with the program read on the memory while appropriately using resources such as the memory and communication interface. Besides the CPU, a GPU (Graphical Processing Unit), a DSP (Digital Signal Processor) and the like are usable as the processor. The processing for implementing the function may be executed by an installed dedicated circuit without being limited to processing by the software program. A FPGA (Field Programmable Gate Array), an ASIC (Application Specific Integrated Circuit) and the like may be applied as the dedicated circuit.

### First Embodiment

In the present invention, an electromagnetic wave generation system is composed of a computing device that computes a structure of an electromagnetic wave containing geometric information (referred to as structured electromagnetic wave), and an electromagnetic wave generation device that generates an electromagnetic wave based on a computed result of the computing device.

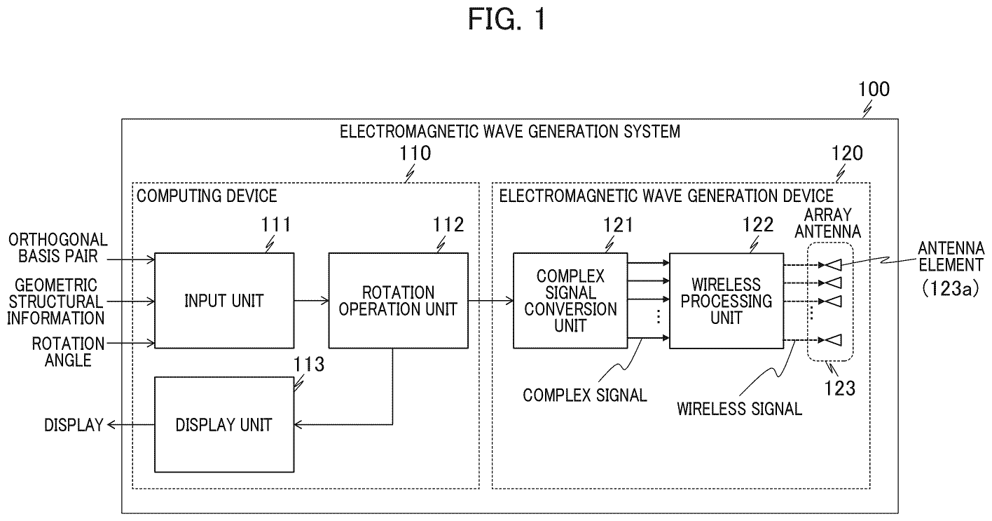

FIG. 1 illustrates a structure example of an electromagnetic wave generation system 100 according to a first embodiment as an exemplified case. The electromagnetic wave generation system 100 as illustrated in FIG. 1 is provided with a computing device 110 and an electromagnetic wave generation device 120. The computing device 110 includes: an input unit 111 that receives, as input information, inputs including an orthogonal basis pair of mutually orthogonal first and second orthogonal bases, geometric structural information containing an azimuth angle, an elevation angle, and a radius, and a rotation angle; a rotation operation unit 112 that rotates the geometric structural information based on the rotation angle; and a display unit 113 that superimposingly displays the geometric structural information rotated by the rotation operation unit 112 on a virtual sphere having the orthogonal basis pair placed at a north pole and a south pole of the sphere, respectively.

The electromagnetic wave generation device 120 includes a complex signal conversion unit 121 that converts the rotated geometric structural information into the same number of complex signals as the number of antenna elements, a wireless processing unit 122 that converts the complex signal into a wireless signal, and an array antenna 123 that outputs the wireless signal as the electromagnetic wave.

The input unit 111 has a function of receiving information input from an input device or other devices such as a keyboard, a mouse, a touch panel and the like (not shown). Alternatively, the input unit may include the input device itself. The display unit 113 generates information for displaying predetermined information on a display device, for example, a not shown display device. The display unit may include the display device itself.

Each processing executed by the rotation operation unit 112, the complex signal conversion unit 121, and the wireless processing unit 122 is described using formulae. Each processing of the respective units may be implemented by a processor (CPU) of a computer, for example, which executes the predetermined program. Alternatively, it may be implemented by a dedicated CPU or hardware.

### <Processing by Rotation Operation Unit 112>

The geometric structural information drawn on the sphere based on the orthogonal basis pair input from the input unit 111 using the azimuth angle φ, the elevation angle θ, and the radius a is expressed by a 2D complex number vector pϵC².

$$\begin{matrix}Formula 1 & \\ p = a [ \begin{matrix}{e}^{- i \frac{ϕ}{2}} cos \frac{θ}{2} \\ {e}^{i \frac{ϕ}{2}} sin \frac{θ}{2}\end{matrix} ] & ( Formula 1 )\end{matrix}$$

The first component of the vector indicates amplitude and a phase of the first orthogonal basis of the pair, and the second component of the vector indicates amplitude and a phase of the second orthogonal basis of the pair. The geometric structure can be expressed by the position on the sphere.

The geometric structural information is expressed by a special unitary group SU(2) to allow description of an arbitrary rotation operation using Lie algebra. The rotation operation performed by the rotation operation unit 112 based on the rotation angle ψ in an arbitrary direction n (hat: in this specification, the letter “A” having a superscript “\hat{ }” as the mathematical symbol placed thereabove is called “A(hat)”) input from the input unit is given by the 2×2 complex matrix D(hat) using Pauli matrix σⱼ(j=1, 2, 3).

$$\begin{matrix}Formula 2 & \\ \hat{𝒟} ( \hat{n} , ψ ) = 1 cos ( \frac{ψ}{2} ) - i σ \cdot \hat{n} sin ( \frac{ψ}{2} ) & ( Formula 2 )\end{matrix}$$

$$\begin{matrix}Formula 3 & \\ 1 = [ \begin{matrix}1 & 0 \\ 0 & 1\end{matrix} ] & ( Formula 3 - 1 )\end{matrix}$$

$$σ = ( {σ}_{1} , {σ}_{2} , {σ}_{3} ) \qquad ( Formula 3 - 2 )$$

$${σ}_{1} = [ \begin{matrix}0 & 1 \\ 1 & 0\end{matrix} ] , {σ}_{2} = [ \begin{matrix}0 & - i \\ i & 0\end{matrix} ] {σ}_{3} = [ \begin{matrix}1 & 0 \\ 0 & - 1\end{matrix} ] \qquad ( Formula 3 - 3 )$$

In the rotation operation performed by the rotation operation unit 112, the formula 2 is applied to the formula 1 to obtain a formula 4 so that the 2D complex number vector is acquired as the rotated geometric structural information.

$$\begin{matrix}Formula 4 & \\ \hat{𝒟} ( \hat{n} , ψ ) \cdot p & ( Formula 4 )\end{matrix}$$

As described above, the present invention allows the use of a mathematically simple process to attain the flexible operation of the geometric structural information.

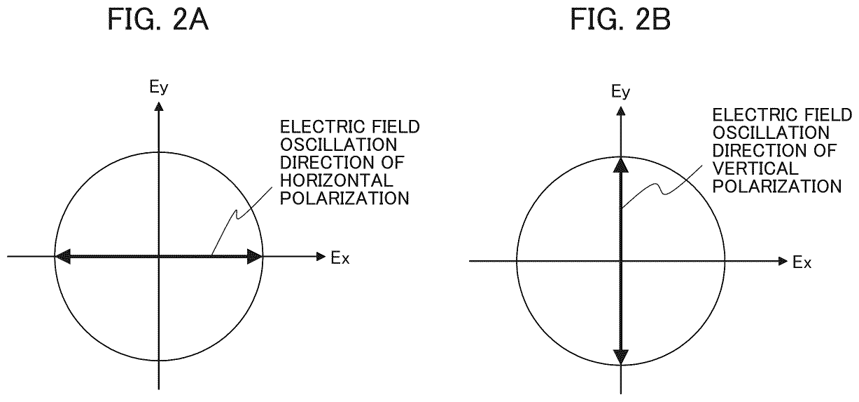

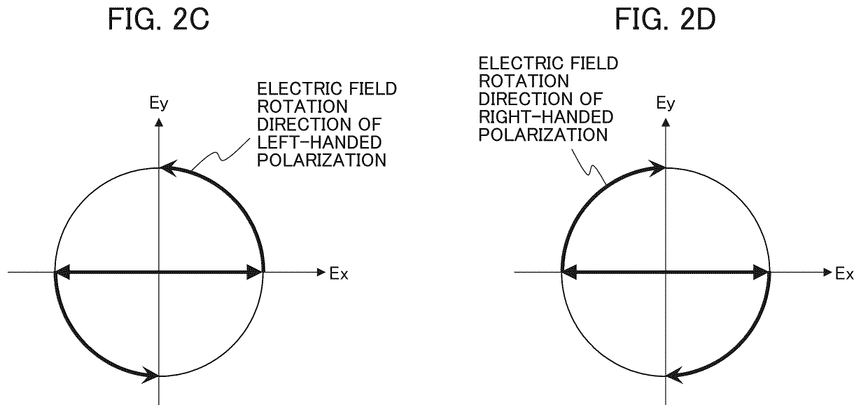

The orthogonal basis constituting the orthogonal basis pair to be input to the input unit 111 may be electric field oscillation of the horizontal polarization as illustrated in FIG. 2A, electric field oscillation of the vertical polarization as illustrated in FIG. 2B, an electric field rotation of the left-handed polarization as illustrated in FIG. 2C, and an electric field rotation of the right-handed polarization as illustrated in FIG. 2D.

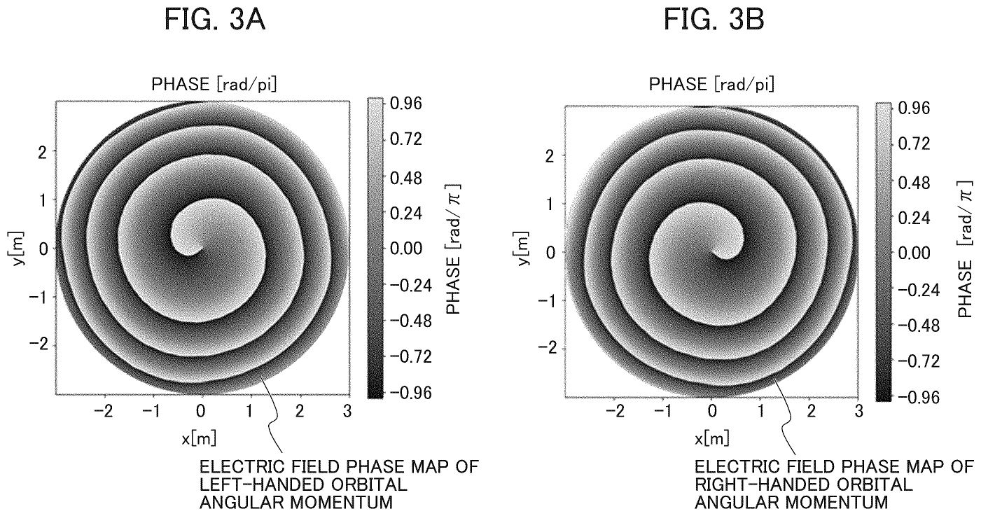

The electromagnetic wave contains the orbital angular momentum that can be used as the orthogonal basis in addition to the orthogonal basis that involves the spin angular momentum. For example, FIG. 3A illustrates an electric field phase map of the left-handed orbital angular momentum, and FIG. 3B illustrates an electric field phase map of the right-handed orbital angular momentum. Each of those drawings illustrates the orbital angular momentum that goes one round at 360°. It is possible, however, to use the orbital angular momentum that goes two rounds, three rounds, or more rounds at 360° as the orthogonal basis.

Furthermore, it is possible to use frequency as the orthogonal basis. As the direct product of them allows formation of the orthogonal basis pair, the orthogonal basis pair can be formed with various degrees of freedom.

### <Processing by Complex Signal Conversion Unit 121 and Wireless Processing Unit 122>

The following is a description of the case that the electromagnetic wave contains the geometric structural information applied with the left-handed and right-handed orbital angular momenta, each going one round at 360° as the orthogonal basis pair. The array antenna 123 is a circular array antenna having N antenna elements 123a circularly arranged.

The complex signal conversion unit 121 converts the geometric structural information expressed by the formula 1 into N complex signals to be radiated from the array antenna 123 composed of N antenna elements 123a. The matrix IQ₁ϵC^{N×2} for conversion into the complex signal is given as follows.

$$\begin{matrix}Formula 5 & \\ {IQ}_{l} = [ \begin{matrix}{e}^{il {ϑ}_{0}} & {e}^{- il {ϑ}_{0}} \\ {e}^{il {ϑ}_{1}} & {e}^{- il {ϑ}_{1}} \\ ⋮ & ⋮ \\ {e}^{il {ϑ}_{N - 1}} & {e}^{- il {ϑ}_{N - 1}}\end{matrix} ] & ( Formula 5 )\end{matrix}$$

In this case, θₙ=2πn/N (n=0, 1, . . . , N−1) denotes a phase of each of the antenna elements 123a of the array antenna 123. The N complex signals are derived from a formula 6 as the product of the formulae 5 and 1.

$$\begin{matrix}Formula 6 & \\ {IQ}_{l} p = a [ \begin{matrix}{e}^{il {ϑ}_{0}} & {e}^{- il {ϑ}_{0}} \\ {e}^{il {ϑ}_{1}} & {e}^{- il {ϑ}_{1}} \\ ⋮ & ⋮ \\ {e}^{il {ϑ}_{N - 1}} & {e}^{- il {ϑ}_{N - 1}}\end{matrix} ] [ \begin{matrix}{e}^{- i \frac{ϕ}{2}} cos \frac{θ}{2} \\ {e}^{i \frac{ϕ}{2}} sin \frac{θ}{2}\end{matrix} ] & ( Formula 6 )\end{matrix}$$

In the wireless processing unit 122, the N complex signals obtained by the above-described complex signal conversion unit 121 are up-converted using the next formula to generate a N-channel wireless signal s(t)ϵR^{N×t} to be supplied to the array.

$$\begin{matrix}Formula 7 & \\ s ( t ) = Real [ {IQ}_{l} {pe}^{i 2 π {f}_{c} t} ] & ( Formula 7 )\end{matrix}$$

where f_{c} denotes a central frequency [Hz] upon up-conversion, and t denotes time [s].

The following is a description about the electromagnetic wave containing the geometric structural information applied with the horizontal polarization and the vertical polarization as the orthogonal basis pair. In this case, the array antenna 123 to be used may be formed of two antenna elements in total, including one antenna element that generates the horizontal polarization and one antenna element that generates the vertical polarization.

The complex signal conversion unit 121 converts the geometric structural information expressed by the formula 1 into two complex signals to be radiated from the array antenna 123 including two antenna elements 123a. The matrix IQ_{HV}ϵR^{2×2} for conversion into the complex signal is given by the following formula.

$$\begin{matrix}Formula 8 & \\ {IQ}_{HV} = [ \begin{matrix}1 & 0 \\ 0 & 1\end{matrix} ] & ( Formula 8 )\end{matrix}$$

A formula 9 as the product of the formulae 8 and 1 provides two complex signals.

$$\begin{matrix}Formula 9 & \\ {IQ}_{HV} p = a [ \begin{matrix}1 & 0 \\ 0 & 1\end{matrix} ] [ \begin{matrix}{e}^{- i \frac{ϕ}{2}} cos \frac{θ}{2} \\ {e}^{i \frac{ϕ}{2}} sin \frac{θ}{2}\end{matrix} ] & ( Formula 9 )\end{matrix}$$

Using the next formula, the wireless processing unit 122 up-converts the two complex signals obtained from the above-described complex signal conversion unit 121 to generate the 2-channel wireless signal s(t)ϵR^{2×t} to be supplied to the array antenna 123.

$$\begin{matrix}Formula 10 & \\ s ( t ) = Real [ {IQ}_{HV} {pe}^{i 2 π {f}_{c} t} ] & ( Formula 10 )\end{matrix}$$

If the left-handed polarization and the right-handed polarization are selected as the basis pair, the wireless signal expressed by the formula 10 is obtained.

The following is a description about another example that the electromagnetic wave contains the geometric structural information applied with frequencies f1 and f2 (f1≠f2) as the orthogonal basis pair. In this case, the array antenna 123 to be used may be formed of two antenna elements in total, including one antenna element that generates the electromagnetic wave at the frequency f1, and one antenna element that generates the electromagnetic wave at the frequency f2.

The complex signal conversion unit 121 converts the geometric structural information expressed by the formula 1 into two complex signals to be radiated from the array antenna 123 including two antenna elements 123a. The matrix IQ_{f}ϵC^{2×t} for conversion into the complex signal is given by the following formula.

$$\begin{matrix}Formula 11 & \\ {IQ}_{f} = [ \begin{matrix}{e}^{i 2 π {f}_{1} t} & 0 \\ 0 & {e}^{i 2 π {f}_{2} t}\end{matrix} ] & ( Formula 11 )\end{matrix}$$

A formula 12 as the product of the formulae 11 and 1 provides two complex signals.

$$\begin{matrix}Formula 12 & \\ {IQ}_{f} p = a [ \begin{matrix}{e}^{i 2 π {f}_{1} t} & 0 \\ 0 & {e}^{i 2 π {f}_{2} t}\end{matrix} ] [ \begin{matrix}{e}^{- i \frac{ϕ}{2}} cos \frac{θ}{2} \\ {e}^{i \frac{ϕ}{2}} sin \frac{θ}{2}\end{matrix} ] & ( Formula 12 )\end{matrix}$$

Using the next formula, the wireless processing unit 122 up-converts the two complex signals obtained from the above-described complex signal conversion unit 121 to generate the 2-channel wireless signal s(t)ϵR^{2×t} to be supplied to the array antenna 123.

$$\begin{matrix}Formula 13 & \\ s ( t ) = Real [ {IQ}_{f} {pe}^{i 2 π {f}_{c} t} ] & ( Formula 13 )\end{matrix}$$

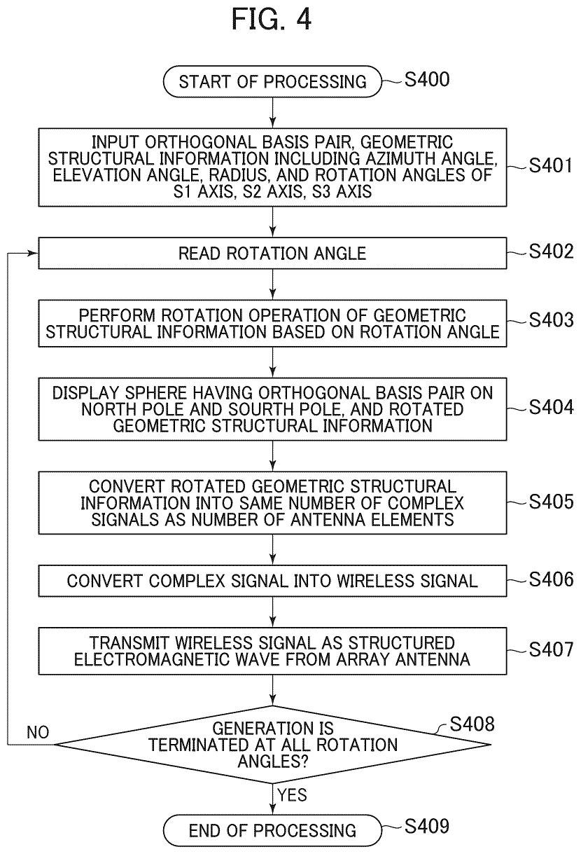

FIG. 4 represents an electric wave generation flow executed by the electromagnetic wave generation system 100 according to the embodiment.

### <Step S401>

Inputs from the input unit 111 are received, which include: the orthogonal basis pair; the geometric structural information containing the azimuth angle, the elevation angle, and the radius; and rotation angles of S1 axis, S2 axis, S3 axis. The number of states of the structured electromagnetic wave to be generated is determined by the type (number) of the rotation angle to be input. Accordingly, the user can appropriately set the type (number) of the rotation angles in accordance with the usage. For example, in the case of application to the radar and the sensor, at least two types of rotation angles may be set for quantifying the interaction between radiation and an object. Setting more types, however, may increase the condition number for quantification, and accordingly, quantitative accuracy can be further improved.

### <Steps S402 and S403>

The rotation operation unit 112 reads the input rotation angle, and performs a rotation operation of the geometric structural information.

### <Step S404>

The display unit 113 displays the sphere having the orthogonal basis pair placed on the north pole and the south pole, and the rotated geometric structural information.

### <Step S405>

The complex signal conversion unit 121 converts the rotated geometric structural information into the same number of complex signals as the number of antenna elements 123a of the array antenna 123.

### <Step S406>

The wireless processing unit 122 converts the complex signal into the wireless signal.

### <Step S407>

The array antenna 123 transmits the wireless signal as the structured electromagnetic wave.

### <Step S408 to S402>

The process returns to step S402 to execute the flow repeatedly until the end of generation of the electromagnetic waves to be transmitted with respect to all rotation angles as set in step S401 (“NO” in step S408). When generation of the electromagnetic waves is finished with respect to all rotation angles (“YES” in step S408), the flow ends (S409).

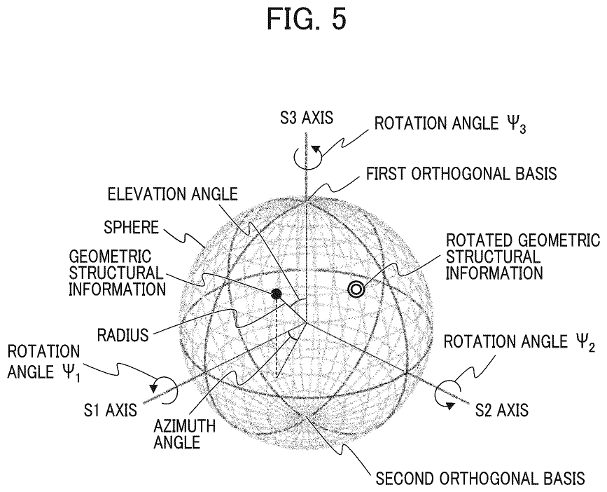

FIG. 5 illustrates a display example of the geometric structural information to be displayed by the display unit 113. The display unit 113 displays the sphere having the first orthogonal basis and the second orthogonal basis of the orthogonal basis pair placed on the north pole and the south pole, respectively, and the geometric structural information obtained by rotating the geometric structural information indicating points on the sphere, defined by the elevation angle, the azimuth angle, and the radius based on rotation angles ψ1, ψ2, ψ3 with respect to the axes of S1, S2, S3, respectively as information input from the input unit 111. As described above, the display unit 113 of the electromagnetic wave generation system according to the present invention is capable of visually expressing the geometric structural information clearly.

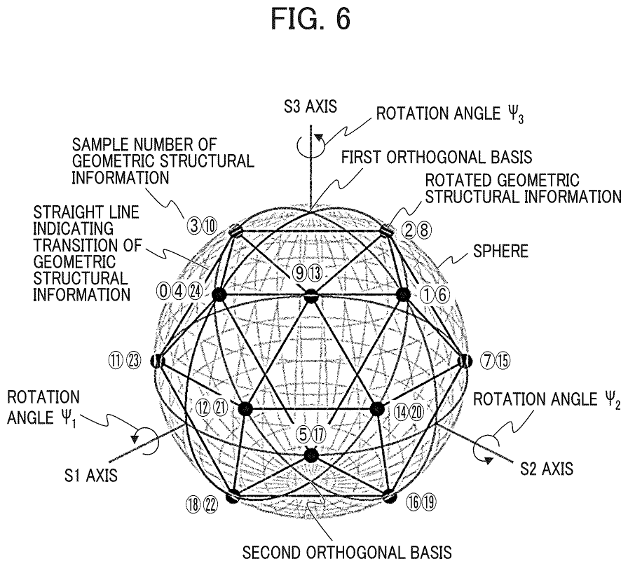

FIG. 6 illustrates another display example of the geometric structural information displayed by the display unit 113. The rotated geometric structural information is expressed by black circles on the sphere having the first orthogonal basis and the second orthogonal basis placed on the north pole and the south pole, respectively in the comparable manner to FIG. 5. The geometric structural information is constantly rotated based on steps S408 to S402 in the electromagnetic wave generation flow as represented in FIG. 4 to allow generation of the structured electromagnetic wave containing a plurality of states. In this example, the geometric structural information is constantly rotated to unicursally draw a cuboctahedral shape. In this example, straight lines each indicating transition of the geometric structural information clearly represents the three-dimensional geometric structure. Circled numbers correspond to sample numbers of the geometric structural information. Tracing of those numbers in order from (0) allows tracing of the unicursal line.

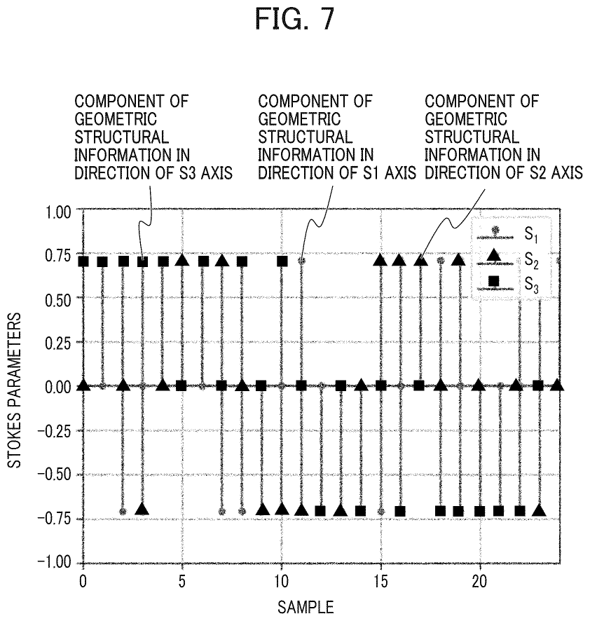

It is possible to express the geometric structural information with respect to components of the S1 axis, S2 axis, S3 axis in a graph as illustrated in FIG. 7, taking the x-axis as the sample number or time, and the y-axis as each component of the respective axes (stoke parameters). This makes it possible to display the information as time-series signals.

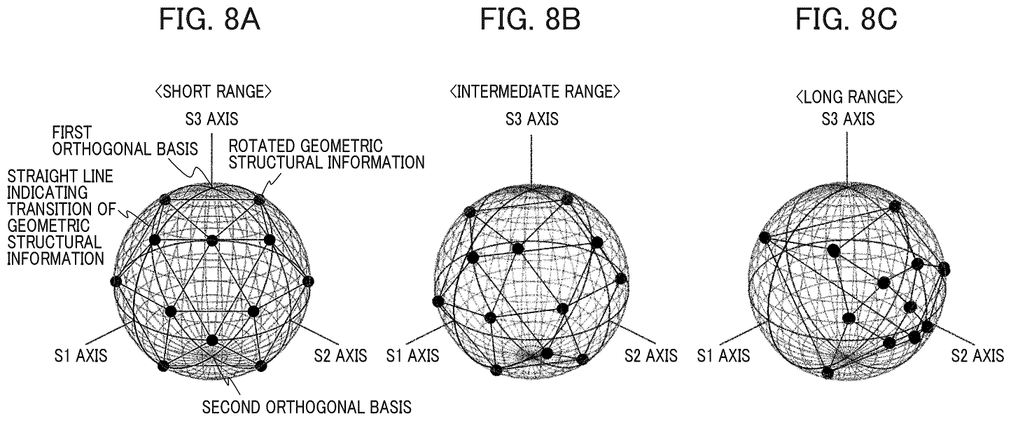

The generated electromagnetic wave suffers the influence of the interaction between the object and radiation during propagation in the environment where reflection and scattering frequently occur, and causes change in the geometric structural information as FIGS. 8A to 8C illustrate. FIG. 8A illustrates a state of change in a short range. Because of the short range, the electromagnetic wave is hardly influenced by the interaction between the object and radiation. The resultant geometric structural information is substantially the same as the one obtained upon transmission (generation) as illustrated in FIG. 6.

As the propagated distance of the electromagnetic wave becomes longer, the interaction between radiation and the object becomes stronger. Referring to the state of change in the intermediate range as illustrated in FIG. 8B or in the long range as illustrated in FIG. 8C, such change appears as rotation of the geometric structural information. It is therefore possible to acquire the information concerning the scatterer and the propagation process as the rotation of the relevant geometric structural information. The electromagnetic wave generation system in this embodiment allows application to the radar and the sensor. Topological information of a polyhedron formed by straight lines each indicating the transition between pieces of the geometric structural information is stored even in the case of long range. This makes it possible to attain information communication robust to the environment.

The electromagnetic wave generated by the electromagnetic wave generation system of this embodiment is received by executing the above-described generation process steps in reverse order so that an analysis operation can be performed. The device at the receiver side may be configured to receive the structured electromagnetic wave by the similar array antenna to the one according to the embodiment, decompose the complex signal into the orthogonal basis components, and acquire the geometric structural information of the received signal on the sphere based on the information about the orthogonal basis pair during transmission.

As described above, the embodiment allows generation of the electromagnetic wave containing the geometric structure based on various types of orthogonal basis pairs. Accordingly, the electromagnetic wave generation system can be configured to allow application to the sensor utilizing characteristics of the respective orthogonal basis pairs, and secure communication using the orthogonal basis pair as the encryption key.

### Second Embodiment

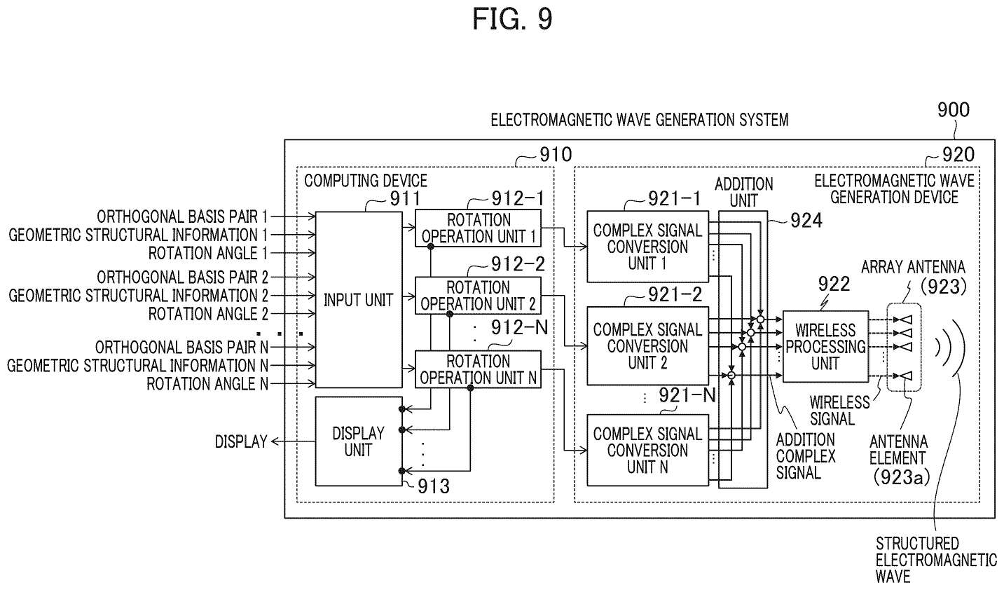

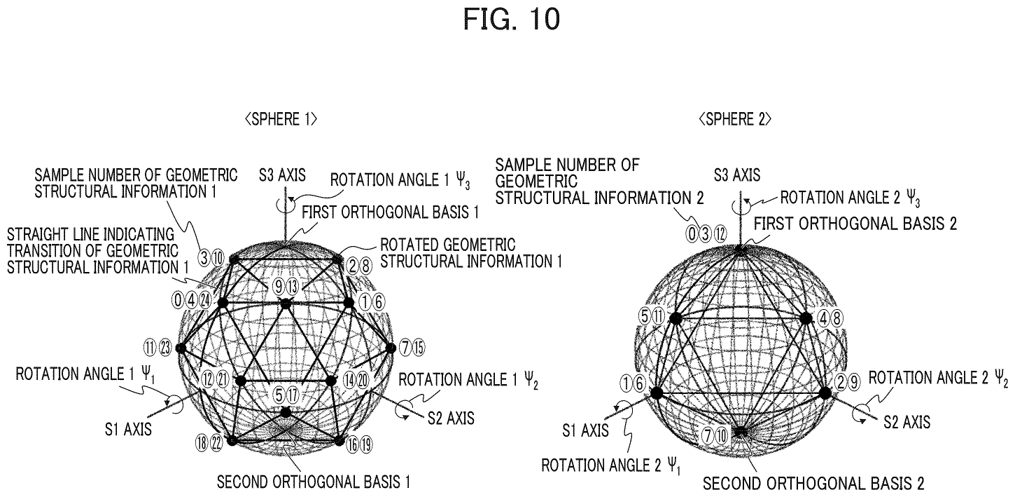

An electromagnetic wave generation system according to a second embodiment will be described with reference to FIGS. 9 and 10. An electromagnetic wave generation system 900 as illustrated in FIG. 9 is provided with a computing device 910 and an electromagnetic wave generation device 920. The computing device 910 includes: an input unit 911 that receives a plurality of input information sets (N sets as illustrated in FIG. 9) each including the orthogonal basis pair, the geometric structural information, the rotation angle; a plurality of rotation operation units 912-1 to 912-N that rotate the geometric structural information of the respective sets based on the rotation angles of the sets input by the input unit 911; and a display unit 913 that superimposingly displays the plurality of sets of the geometric structural information rotated by the rotation operation units 912-1 to 912-N on a plurality of virtual spheres each having the orthogonal basis pair placed on the north pole and the south pole, respectively. The number of the rotation operation units 912-1 to 912-N does not have to be physically set to N. It is possible to impart the equivalent functions to a single unit of the rotation operation unit 912.

The electromagnetic wave generation device 920 includes complex signal conversion units 921-1 to 921-N that convert the plurality of pieces of geometric structural information rotated by the rotation operation units 912-1 to 912-N into the same number of complex signals as that of antenna elements 923a of an array antenna 923, an addition unit 924 that adds the respective complex signals from the complex signal conversion units 921-1 to 921-N for conversion into addition complex signals, and a wireless processing unit 922 that converts the addition complex signals from the addition unit 924 into wireless signals. The number of the complex signal conversion units 921-1 to 921-N does not have to be physically set to N. It is possible to impart the equivalent functions to a single unit of the complex signal conversion unit 921. As specific processing to be performed by the complex signal conversion units 921-1 to 921-N, and the wireless processing unit 922 is similar to the processing executed by those units as described in the first embodiment, the description on the processing will be omitted.

FIG. 10 illustrates a display example of the geometric structural information to be displayed by the display unit 913 of the electromagnetic wave generation system 900 according to the second embodiment. In this example, two orthogonal basis pairs and two sets of geometric structural information are input by the input unit 911. The drawing shows results of constantly inputting the respective rotation angles for rotation operations with respect to the respective sets of geometric structural information. A sphere 1 corresponding to the first orthogonal basis of the pair has the geometric structural information of a unicursally drawn cuboctahedral shape in a comparable manner to the one illustrated in FIG. 6. A sphere 2 corresponding to the second orthogonal basis of the pair has the geometric structural information of a unicursally drawn regular octahedral shape.

As described above, in the embodiment, the electromagnetic wave generated from the array antenna 923 becomes the structured electromagnetic wave containing a plurality of polyhedral structures using the geometric structural information. Accordingly, the electromagnetic wave generation system allows application to the communication and the sensor based on transmission of the topological information using the plurality of polyhedral structures.

### Third Embodiment

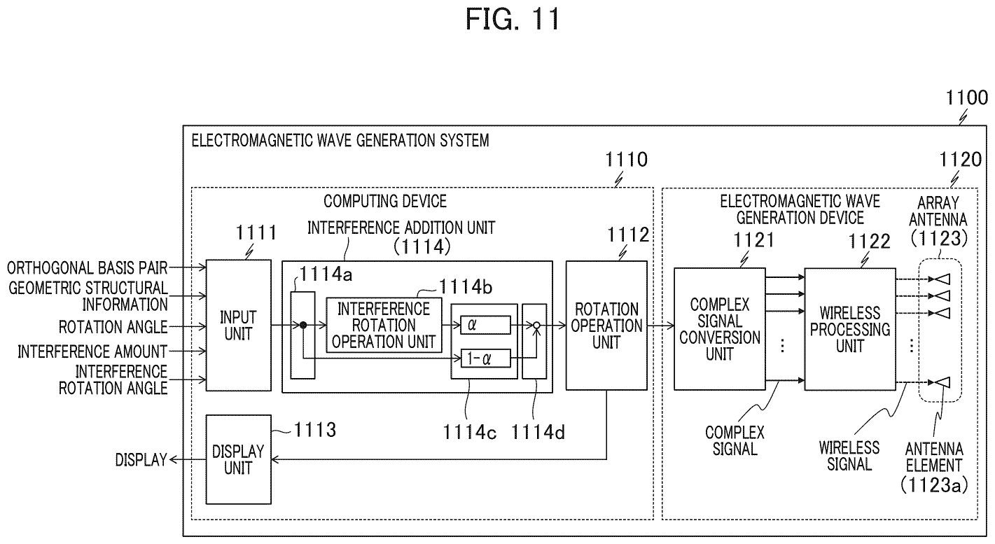

An electromagnetic wave generation system according to a third embodiment will be described with reference to FIGS. 11 to 13. An electromagnetic wave generation system 1100 as illustrated in FIG. 11 is provided with a computing device 1110 and an electromagnetic wave generation device 1120. The computing device 1110 includes an input unit 1111, a rotation operation unit 1112, a display unit 1113, and an interference addition unit 1114. Specifically, the electromagnetic wave generation system is constituted by adding the interference addition unit 1114 to the electromagnetic wave generation system 100 according to the first embodiment (FIG. 1).

The input unit 1111 receives inputs including an interference amount and an interference rotation angle in addition to the orthogonal basis pair, the geometric structural information, and the rotation angle.

The interference addition unit 1114 includes: a branch unit 1114a that branches the geometric structural information input from the input unit 1111; an interference rotation operation unit 1114b that performs an interference rotation operation based on an interference rotation angle received by the input unit 1111, on one side of the branched geometric structural information; an interference amount set unit 1114c that sets interference amounts with respect to the geometric structural information subjected to the interference rotation operation by the interference rotation operation unit 1114b and the geometric structural information from the input unit 1111; and an addition unit 1114d that adds the geometric structural information from the interference amount set unit 1114c.

The geometric structural information obtained by the rotation operation based on the interference rotation angle φ in an arbitrary direction n(hat) in the interference rotation operation unit 1114b is given by the following formula.

$$\begin{matrix}Formula 14 & \\ \hat{𝒟} ( \hat{n} , φ ) \cdot p & ( Formula 14 )\end{matrix}$$

where p denotes the geometric structural information as a source expressed by the formula 1.

In the interference amount set unit 1114c and the addition unit 114d, the interference amount is set, based on the following formula, with respect to the geometric structural information obtained by the rotation operation by the interference rotation operation unit 1114b based on the input interference amount a, and the original geometric structural information for performing addition.

$$\begin{matrix}Formula 15 & \\ α \hat{𝒟} ( \hat{n} , φ ) \cdot p + ( 1 - α ) p & ( Formula 15 )\end{matrix}$$

This makes it possible to control the input geometric structural information in the radial direction in accordance with the interference amount a and the interference rotation angle.

The electromagnetic wave generation device 1120 includes a complex signal conversion unit 1121, a wireless processing unit 1122, and an array antenna 1123. The complex signal conversion unit 1121 substitutes the formula 15 for “p” of the formula 6 for the complex signal conversion unit 121 according to the first embodiment so that the complex signal can be obtained. As the wireless processing unit 1122 and the array antenna 1123 are similar to those described in the first embodiment, description of those components is omitted.

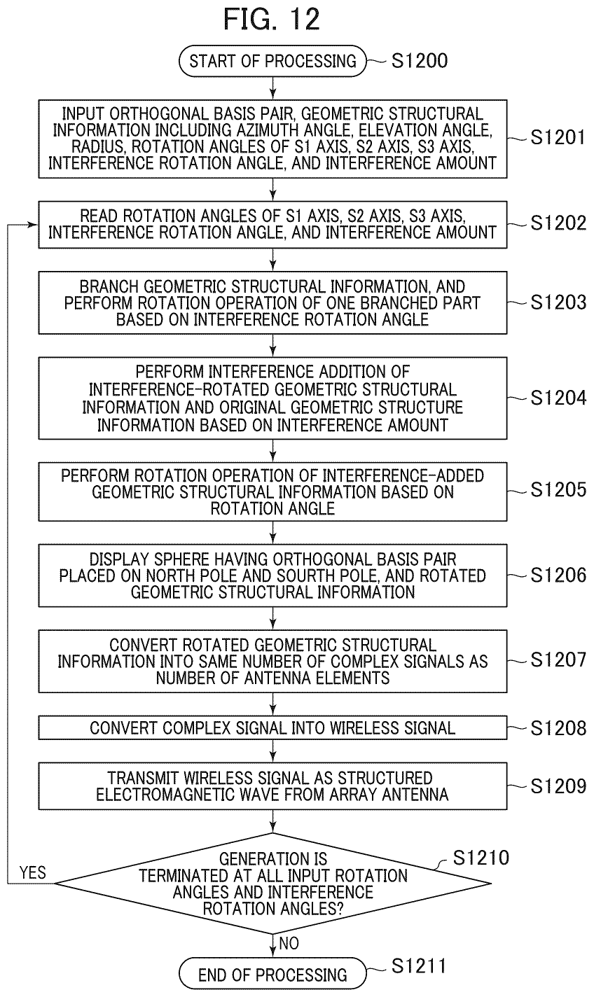

FIG. 12 represents an electric field generation flow performed by the electromagnetic wave generation system 1100 according to this embodiment.

### <Step S1201>

Inputs from the input unit 111 are received, which includes: the orthogonal basis pair; the geometric structural information containing the azimuth angle, the elevation angle, and the radius; the rotation angles of axes of S1, S2, S3; the interference rotation angle; and the interference amount.

### <Step S1202>

The rotation operation unit 1112 and the interference addition unit 1114 read input information including the rotation angle, the interference rotation angle, and the interference amount.

### <Step S1203>

The branch unit 1114a of the interference addition unit 1114 branches the input geometric structural information. The interference rotation operation unit 1114b performs a rotation operation of one branched part of the information based on the interference rotation angle.

### <Step S1204>

The interference amount set unit 1114c and the addition unit 1114d set the interference amount with respect to the geometric structural information obtained from the rotation operation by the interference rotation operation unit 1114b based on the input interference amount a, and the original geometric structural information for performing the interference addition.

### <Step S1205>

The rotation operation unit 1112 reads the input rotation angle, and performs a rotation operation of the geometric structural information from the interference addition unit 1114.

### <Step S1206>

The display unit 1113 displays the sphere having the orthogonal basis pair placed on the north pole and the south pole, and the rotated geometric structural information.

### <Step S1207>

The complex signal conversion unit 1121 converts the rotated geometric structural information into the same number of complex signals as the number of the antenna elements 1123a of the array antenna 1123.

### <Step S1208>

The wireless processing unit 1122 converts the complex signal into a wireless signal.

### <Step S1209>

The array antenna 1123 transmits the wireless signal as a structured electromagnetic wave.

### <Step S1210 to S1202>

The process returns to step S1202 to execute the flow as described above repeatedly until the end of generation of the electromagnetic waves to be transmitted with respect to all rotation angles, interference rotation angles, and interference amounts, which have been set in step S1201 (“NO” in step S1210). When generation of the electromagnetic waves is finished with respect to all rotation angles, interference rotation angles, and interference amounts (“YES” in step S1210), the flow ends (S1211).

The electromagnetic generation flow as described above allows generation of the electromagnetic wave containing complex geometric structural information by controlling its amplitude direction and rotating direction.

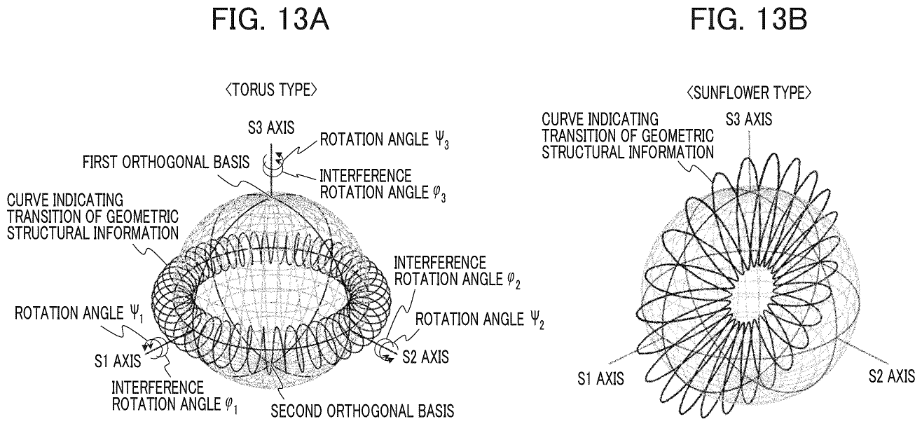

FIGS. 13A and 13B illustrate examples that the electromagnetic waves generated by executing the electromagnetic wave generation flow in FIG. 12 are displayed by the display unit 1113 of the electromagnetic wave generation system 1100. FIG. 13A illustrates an example of generating a torus type structured electromagnetic wave. Firstly, in step S1201, the geometric structural information indicating the S1 axis is input as an initial value. Secondly, the interference addition operation is performed with respect to the rotated geometric structural information by inputting the rotation interference angle φ2 in the direction of S2 axis, and the original geometric structural information to generate the geometric structural information indicating a circle in a poloidal direction (steps S1202 to S1204). Thereafter, the rotation angle ψ3 in the direction of S3 axis is input to perform the rotation operation in the toroidal direction (step S1205). This makes it possible to form the torus shape.

Meanwhile, a structured electromagnetic wave of sunflower type as illustrated in FIG. 13B is generated similarly to the torus type up to the interference addition processing (step S1202 to S1204). As the rotation angle ψ2 in the direction of S2 axis is input, the sunflower shape can be formed (steps S1202 to S1204).

In the embodiment as described above, the effect of interference addition allows transmission of the structured electromagnetic wave containing the operated geometric structural information even in the radial direction of the sphere of torus type or sunflower type. The electromagnetic wave generation system allows application to the communication and the sensor.

### Fourth Embodiment

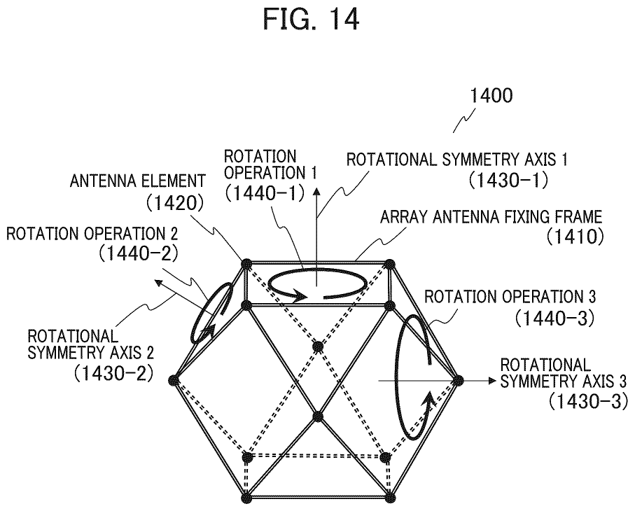

In the respective embodiments, the array antenna 123 is formed into a circular shape by circularly arranging the antenna elements 123a. The array antenna to be used in the present invention is not limited to the one as described above. FIG. 14 illustrates another example of the array antenna formed by arranging one or more rotational symmetry axes, and antenna elements to be rotationally operated at 120° or smaller around the respective rotational symmetry axes. The drawing illustrates an example of a 12-channel array antenna 1400 having 12 antenna elements (1420) on the respective vertexes of the cuboctahedron using array antenna fixing frames 1410.

The array antenna 1400 includes three rotational symmetry axes 1 (1430-1) each penetrating through a rectangular opening, four rotational symmetry axes 2 (1430-2) each penetrating through a triangular opening, and six rotational symmetry axes 3 (1430-3) each penetrating through the vertex of the antenna element (FIG. 14 only shows each one of the representative rotational symmetry axes from 1 to 3).

The rotational symmetry axis 1 or 3 of the rotational symmetry axes 1 to 3 allows formation of a group of the antenna elements arranged for the rotation operation at 90°. Meanwhile, the rotational symmetry axis 2 allows formation of a group of the antenna elements arranged for the rotation operation at 120°. The use of those groups allows configuration of the electromagnetic wave generation system that can generate the electromagnetic wave containing the geometric structure using various orthogonal basis pairs such as the orthogonal basis pairs of the left-handed orbital angular momentum and the right-handed orbital angular momentum in the respective directions.

### Fifth Embodiment

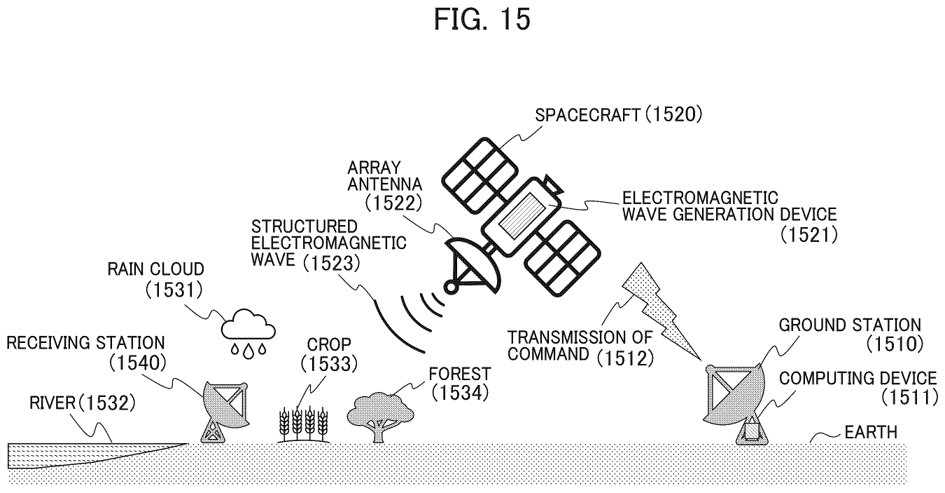

FIG. 15 illustrates a configuration example of a ground station and a spacecraft, using the electromagnetic wave generation system according to the respective embodiments as described above. Specifically, a computing device 1511 that computes a structure of the electromagnetic wave containing geometric information is installed in a ground station 1510 on the earth. A spacecraft 1520 is provided with an electromagnetic wave generation device 1521 that generates the electromagnetic wave based on the computed result from the computing device 1511. The ground station 1510 transmits the geometric structural information rotated by the computing device 1511, and an orthogonal basis pair input from a not shown input unit to the spacecraft 1520 by a command transmission 1512. The spacecraft 1520 generates a structured electromagnetic wave 1523.

Transmission of electromagnetic waves from space to observation objects such as a rain cloud 1531, a river 1532, a crop 1533, a forest 1534, and a receiving station 1540 as a communication object allows configuration of the electromagnetic wave generation system that attains the wide-ranged sensing and communication.

### Sixth Embodiment

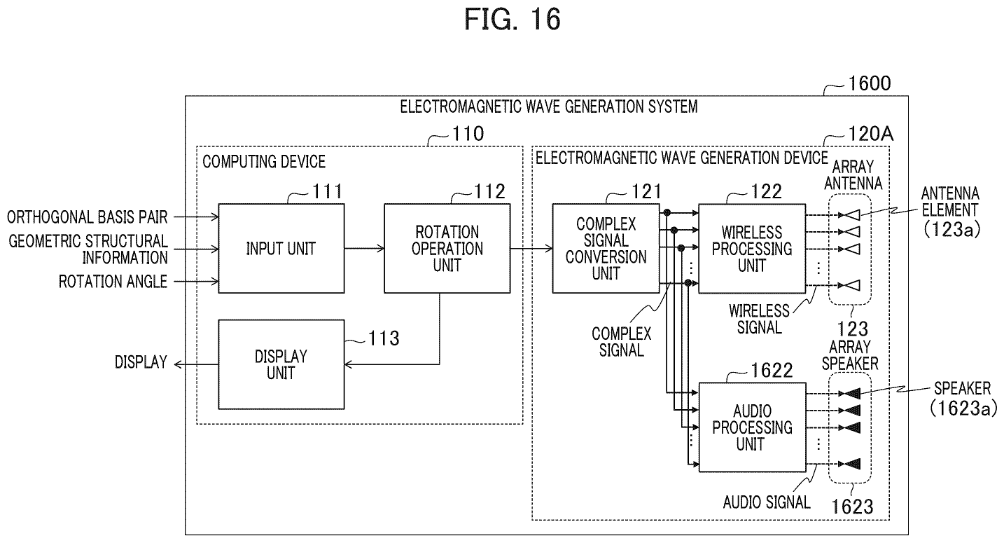

This embodiment will be described as a configuration that makes the structured electromagnetic wave generated in the respective embodiments audible as an audio signal. FIG. 16 illustrates a structure of an electromagnetic wave generation system 1600 according to the embodiment. The electromagnetic wave generation system 1600 is different in an electromagnetic wave generation device 120A that is formed by adding an audio processing unit 1622 for converting the complex signal from the complex signal conversion unit 121 into an audio signal, and an array speaker 1623 composed of a plurality of speakers 1623a for outputting the audio signal from the audio processing unit 1622 as a sound to the electromagnetic wave generation device 120 of the electromagnetic wave generation system 100 as illustrated in FIG. 1. The configuration as described above makes the geometric structural information set by the input unit 111 audible as a sound. This makes it possible to design the structured electromagnetic wave based on the hearing sense, and attain application to an audio communication field.

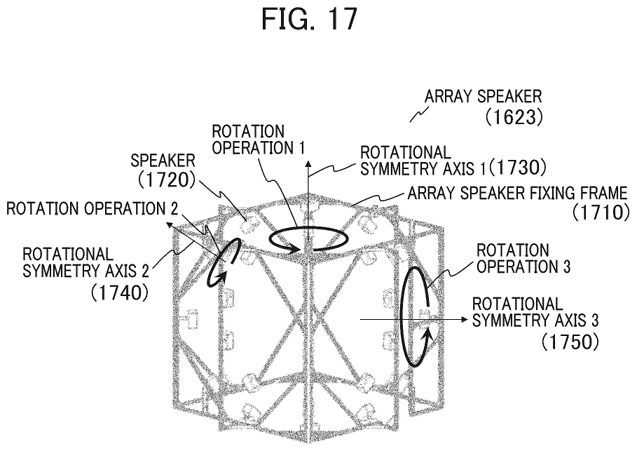

FIG. 17 illustrates an example of the array speaker 1623 according to the embodiment. The example illustrates an example of a 26-channel array speaker having 12 speakers on the respective vertexes of the cuboctahedron, and 14 speakers on the respective vertexes of a rhombic dodecahedron as a dual polyhedron of the cuboctahedron using array speaker fixing frames 1710.

The array speaker 1623 includes three rotational symmetry axes 1 (1710) each penetrating through a rectangular opening of the cuboctahedron, four rotational symmetry axes 2 (1740) each penetrating through a triangular opening, and six rotational symmetry axes 3 (1750) each penetrating through the vertex of the speaker (FIG. 17 only shows each one of the representative rotational symmetry axes from 1 to 3).

The rotational symmetry axis 1 (1710) or 3 (1750) of the rotational symmetry axes 1 to 3 allows formation of a group of the speakers arranged for the rotation operation at 90°. Meanwhile, the rotational symmetry axis 2 (1740) allows formation of a group of the speakers arranged for the rotation operation at 120°. The use of those groups allows configuration of the electromagnetic wave generation system that makes a sound wave audible as a sound, which is similar to the electromagnetic wave containing the geometric structure using various orthogonal basis pairs such as the orthogonal basis pairs of the left-handed orbital angular momentum and right-handed orbital angular momentum in the respective directions.

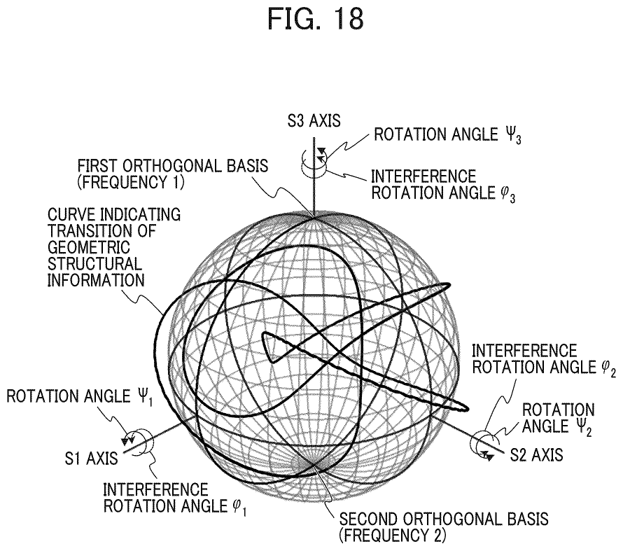

FIG. 18 illustrates a display example displayed by the display unit 113 of the electromagnetic wave generation system 1600 according to the embodiment. In this example, the sphere is formed using mutually different frequencies 1 and 2 as the orthogonal basis pair. A curve is designed to indicate the transition of the geometric structural information. The sound corresponding to the curve is generated from the array speaker 1623 so as to be audible.

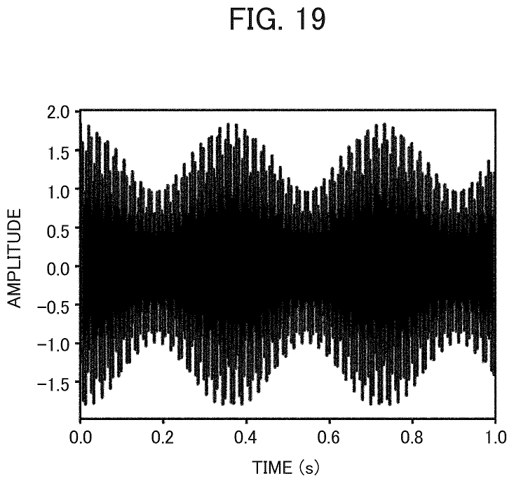

FIG. 19 illustrates an example that the transition of the geometric structural information as illustrated in FIG. 18 is converted into an audio signal using the audio processing unit 1622. The graph having the x-axis indicating time, and the y-axis indicating amplitude represents that the amplitude and phase of the frequency 1 as the first orthogonal basis and those of the frequency 2 as the second orthogonal basis are obtained as audio signals modulated based on the transition of the geometric structural information as illustrated in FIG. 18.

The slow amplitude modulation is derived from the modulation in a radial direction, and the quick amplitude component is derived from components of the frequencies 1 and 2. Sounds heard from the array speaker 1623 makes the geometric structural information as illustrated in FIG. 18 audible. According to the embodiment, the electromagnetic wave containing the geometric structural information can be designed through the use of the auditory information.

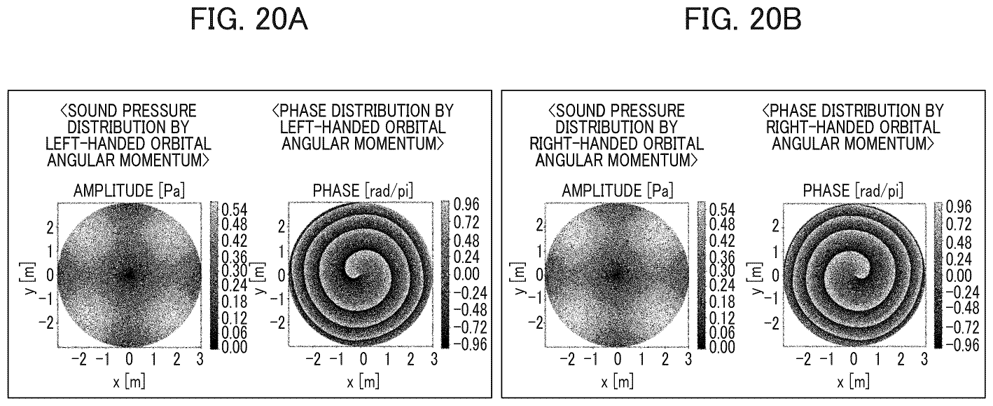

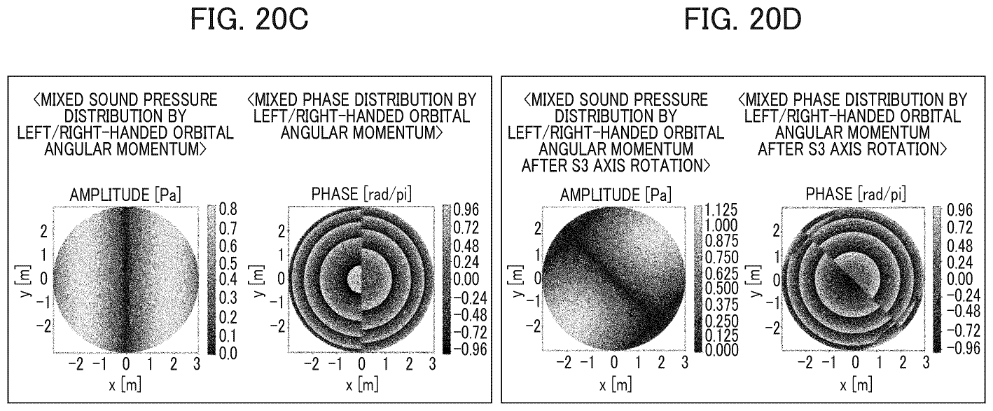

Operation of sounds (sound wave) radiated from the array speaker 1623 with respect to the sound pressure distribution and the phase distribution allows configuration of an acoustic vibrator machine that attains transfer of the auditory information and flexible control. FIGS. 20A to 20D illustrate characteristics of the sound wave radiated from the array speaker 1623 of the electromagnetic wave generation system 1600 according to the embodiment. Those images are generated based on the geometric structural information having the orthogonal basis pair composed of a left-handed orbital angular momentum and a right-handed orbital angular momentum, each making one round at 360°.

FIG. 20A illustrates a sound pressure distribution and a phase distribution of the left-handed orbital angular momentum upon radiation of a sound wave to the geometric structural information on the north pole of the sphere. The drawing clearly shows that the center amplitude of the sound pressure distribution becomes zero, and the left-handed phase of the phase distribution makes advancement.

FIG. 20B illustrates a sound pressure distribution and a phase distribution of the right-handed orbital angular momentum upon radiation of a sound wave to the geometric structural information on the south pole of the sphere. The drawing clearly shows that the center amplitude of the sound pressure distribution becomes zero, and the right-handed phase of the phase distribution makes advancement.

FIG. 20C illustrates a mixed sound pressure distribution and a mixed phase distribution of the left-handed and right-handed orbital angular momentum upon radiation of a sound wave to the geometric structural information with respect to the S1 axis on the sphere. Referring to the sound pressure distribution, the amplitude becomes zero on the line at which mutual cancellation of the left-handed and right-handed phases occurs. Referring to the phase distribution, a dipole characteristic is observed, indicating that the phases at left and right sides with respect to the line are inverted.

FIG. 20D illustrates a mixed sound pressure distribution and a mixed phase distribution of the left-handed and right-handed orbital angular momentum after rotation with respect to the S3 axis when the geometric structural information as illustrated in FIG. 20C is rotated around the S3 axis, and a sound wave is radiated to the geometric structural information with respect to the S2 axis on the sphere. The drawing shows that the dipole characteristic is rotated by the rotation operation.

The respective structures of the embodiments may be arbitrarily modified within the scope of the present invention. It is also possible to replace a component of an embodiment with a component of another embodiment.

What is claimed is:

1. An electromagnetic wave generation system comprising a computing device and an electromagnetic wave generation device, wherein,
the computing device includes:
an input unit that receives inputs including an orthogonal basis pair of mutually orthogonal first and second orthogonal bases, geometric structural information containing an azimuth angle, an elevation angle, a radius, and a rotation angle;
a rotation operation unit that rotates the geometric structural information based on the rotation angle; and
a display unit that displays a sphere having the orthogonal basis pair placed on a north pole and a south pole, and the rotated geometric structural information on the sphere, and
the electromagnetic wave generation device includes:
a complex signal conversion unit that converts the rotated geometric structural information into the same number of complex signals as the number of antenna elements;
a wireless processing unit that converts the complex signal into a wireless signal; and
an array antenna that outputs the wireless signal.

2. The electromagnetic wave generation system according to claim 1, wherein
the orthogonal basis pair is formed of any pair selected from a group consisting of a horizontal polarization, a vertical polarization, a left-handed polarization, a right-handed polarization, a left-handed orbital angular momentum, a right-handed orbital angular momentum, and a frequency, or a direct product of the pair selected from the group.

3. The electromagnetic wave generation system according to claim 1, wherein:
the input unit receives a plurality of sets of input information having the orthogonal basis pair, the geometric structural information, and the rotation angle;
the rotation operation unit rotates the geometric structural information of each one of the input information sets based on the rotation angle of the each one of the input information sets;
the display unit displays a plurality of spheres based on a plurality of orthogonal basis pairs received by the input unit, and the rotated geometric structural information on the respective spheres;
the complex signal conversion unit converts each of the plurality of pieces of the rotated geometric structural information into the same number of complex signals as the number of the antenna elements;
an addition unit is provided to add the respective complex signals for conversion into the same number of addition complex signals as the number of the antenna elements; and
the wiring processing unit converts the addition complex signal into a wireless signal.

4. The electromagnetic wave generation system according to claim 1, wherein,
the input unit further receives inputs including an interference amount and an interference rotation angle,
an interference addition unit is provided to interfere the geometric structural information,
the interference addition unit includes:
a branch unit that branches the geometric structural information received by the input unit;
an interference rotation operation unit that performs a rotation operation of one branched part of the geometric structural information using the interference rotation angle;
an interference amount set unit capable of setting the interference amount with respect to the geometric structural information received by the input unit, and the geometric structural information rotated by the interference rotation operation unit; and
an interference addition unit that adds each piece of the geometric structural information from the interference amount set unit, and
the rotation operation unit performs the rotation operation of the geometric structural information from the interference addition unit using the rotation angle.

5. The electromagnetic wave generation system according to claim 1, wherein
the array antenna is formed to have one or more rotational symmetry axes, and perform the rotation operation at 120° or smaller.

6. The electromagnetic wave generation system according to claim 1, wherein:
the computing device is installed in a ground station on the earth;
the electromagnetic wave generation device is installed in a spacecraft; and
the ground station transmits a command including the rotated geometric structural information and the orthogonal basis pair to the spacecraft.

7. The electromagnetic wave generation system according to claim 1, wherein
the electromagnetic wave generation device includes:
an audio processing unit that converts the complex signal into an audio signal; and
an array speaker that outputs the audio signal.

8. A ground station comprising:
an input unit that receives inputs including an orthogonal basis pair of mutually orthogonal first and second orthogonal bases, geometric structural information containing an azimuth angle, an elevation angle, a radius, and a rotation angle;
a rotation operation unit that rotates the geometric structural information based on the rotation angle; and
a display unit that displays a sphere having the orthogonal basis pair placed on a north pole and a south pole, and the rotated geometric structural information on the sphere, wherein,
the ground station transmits a command including the rotated geometric structural information and the orthogonal basis pair to a spacecraft, and
the spacecraft includes an electromagnetic wave generation device provided with:
a complex signal conversion unit that converts the rotated geometric structural information into the same number of complex signals as the number of antenna elements;
a wireless processing unit that converts the complex signal into a wireless signal; and
an array antenna that outputs the wireless signal.
